(19) United States
(12) Patent Application Publication
(10) Pub. No.: US 2015/0112750 A1
(43) Pub. Date: Apr. 23, 2015

(54) SUPPLY NETWORK OPTIMIZATION METHOD AND SYSTEM FOR MULTIPLE OBJECTIVES

(71) Applicant: Caterpillar, Inc., Peoria, IL (US)

(72) Inventors: Anthony James GRICHNIK, Eureka, IL (US); Christos NIKOLOPOULOS, Peoria, IL (US); Adam BYERLY, East Peoria, IL (US); Ethan HILL, Wheaton, IL (US); Brendan KELLY, St. Louis, MO (US); Tatiana Georgievna KALGANOVA, Iver (GB); Marco VELUSCEK, Padova (PD) (IT); Peter BROOMHEAD, Iver (GB)

(73) Assignee: Caterpillar, Inc., Peoria, IL (US)

(21) Appl. No.: 14/280,296

(22) Filed: May 16, 2014

Related U.S. Application Data
(60) Provisional application No. 61/940,946, filed on Feb. 18, 2014.
(60) Provisional application No. 61/891,974, filed on Oct. 17, 2013.

(51) Int. Cl. G06Q 10/06

(52) U.S. Cl. CPC G06Q 10/06313; G06Q 10/067
USPC 705/7.23

(57) ABSTRACT

The present disclosure is directed to a computer-implemented method for designing a supply chain for multiple objectives based on a supply chain model. The method comprises defining a plurality of objectives for the supply chain model. The supply chain model includes a plurality of edges connecting one or more demands with one or more supplies. The method further includes selecting a first one of the plurality of objectives and at least a second one of the plurality of objectives and configuring, using a controller, the supply chain model for the first objective. The method further comprises identifying, using the controller, a subset of the plurality of edges based on the supply chain model configured for the first objective and relationships between the plurality of edges and the at least second objective. The method further comprises operating the supply chain according to the identified subset of the plurality of edges.

### CROSS REFERENCE TO RELATED APPLICATIONS

This application claims the benefit of priority to U.S. Provisional Application No. 61/940,946, filed Feb. 18, 2014 and U.S. Provisional Application No. 61/891,974, filed Oct. 17, 2013, which are hereby incorporated by reference in their entireties.

### TECHNICAL FIELD

This disclosure relates generally to systems and methods for supply chain network optimization, and more particularly, to systems and methods for supply chain optimizations for multiple objectives.

### BACKGROUND

Supply chain planning may be essential to the success of many of today's companies. Most companies may rely on supply chain planning to ensure the timely and reliable delivery of products in response to customer demands. Conventional supply chain planning techniques use linear programming to model functioning of different aspects of a supply chain, from the supply of components to meet production demands to the time and duration of transportation of finished goods from the factory to the customer.

For example, U.S. Pat. No. 8,429,035 B1, to Kamath et al. (“the '035 patent”) discloses a supply chain planner that prioritizes and models the business objectives as a hierarchy of linear programming objective functions. The supply chain planner may then solve the linear programming problem by variable fixing. After every objective function is solved, the supply chain planner may review the reduced costs of the variables to ensure that optimization of the lower objective function does not degrade the higher objective function.

The technique disclosed in the '035 patent is based on linear programming and may produce a result that is optimal locally, but suboptimal globally for a supply chain network. For example, although the result based on the linear programming may provide minimal costs at a subset of nodes within the network, the cost associated with the overall network is often not minimized. In addition, even if the cost of the overall network is minimized, the technique of the '035 patent fails to consider other important objectives of a supply chain network—such as profits of the business, resilience of the network, and environmental impacts of the distribution scheme—simultaneously in deriving the results. The supply chain management system of the present disclosure is directed toward solving the problem set forth above and/or other problems of the prior art.

### SUMMARY

In one aspect, the present disclosure is directed to a computer-implemented method for designing a supply chain for multiple objectives based on a supply chain model. The method comprises defining a plurality of objectives for the supply chain model. The supply chain model includes a plurality of edges connecting one or more demands with one or more supplies. The method further includes selecting a first one of the plurality of objectives and at least a second one of the plurality of objectives and configuring, using a controller, the supply chain model for the first objective. The method further comprises identifying, using the controller, a subset of the plurality of edges based on the supply chain model configured for the first objective and relationships between the plurality of edges and the at least second objective. The method further comprises operating the supply chain according to the identified subset of the plurality of edges.

In another aspect, the present disclosure is directed to a computer-implemented method for operating a supply chain. The method comprises defining a supply chain model for the supply chain. The supply chain model includes a plurality of edges connecting a plurality of demands with a plurality of supplies. The method further comprises defining a first objective and a second objective for the supply chain model and configuring, by a processor, the supply chain model for the first objective. The configured supply chain model indicates contributions by the plurality of edges to the first objective. The method further comprises determining, by the processor, contributions by the plurality of edges to the second objective based on the supply chain model configured for the first objective, identifying a subset of edges based on the contributions by the plurality of edges to the first objective and the contributions by the plurality of edges to the second objective, and operating the supply chain according to the identified subset of edges.

In yet another aspect, the present disclosure is directed to a computer-implemented method for optimizing a supply chain. The method comprises defining a supply chain model for the supply chain. The supply chain model includes a plurality of edges connecting a plurality of demands with a plurality of supplies. The method comprises defining a first objective and a second objective for the supply chain model, iteratively removing a portion of the plurality of edges from the supply chain model based on first contributions by the plurality of edges to the first objective and second contributions by the plurality of edges to the second objective, and operating the supply chain according to remaining edges in the supply chain model.

### BRIEF DESCRIPTION OF THE DRAWINGS

FIG. 1 is a schematic illustration of an exemplary supply chain in which the supply chain optimization system consistent with the disclosed embodiments may be implemented.

FIG. 2 is a schematic illustration of an exemplary supply chain optimization system consistent with certain disclosed embodiments.

FIGS. 3A and 3B illustrate a flow chart of an exemplary process for supply chain optimization by considering multiple objectives, consistent with a disclosed embodiment.

FIG. 4 is a supply chain model of a supply chain on which the supply chain optimization process is applied, according to an embodiment.

FIG. 5 is a supply chain model including only the subset of edges identified by the supply chain optimization system.

FIG. 6 is a first list including the edges of the supply chain model ranked for the first objective, according to an embodiment.

FIG. 7 is a second list including the edges of the supply chain model ranked for the second objective, according to an embodiment.

FIG. 8 is a third set of edges determined based on the first set of edges and the second set of edges, according to an embodiment.

### DETAILED DESCRIPTION

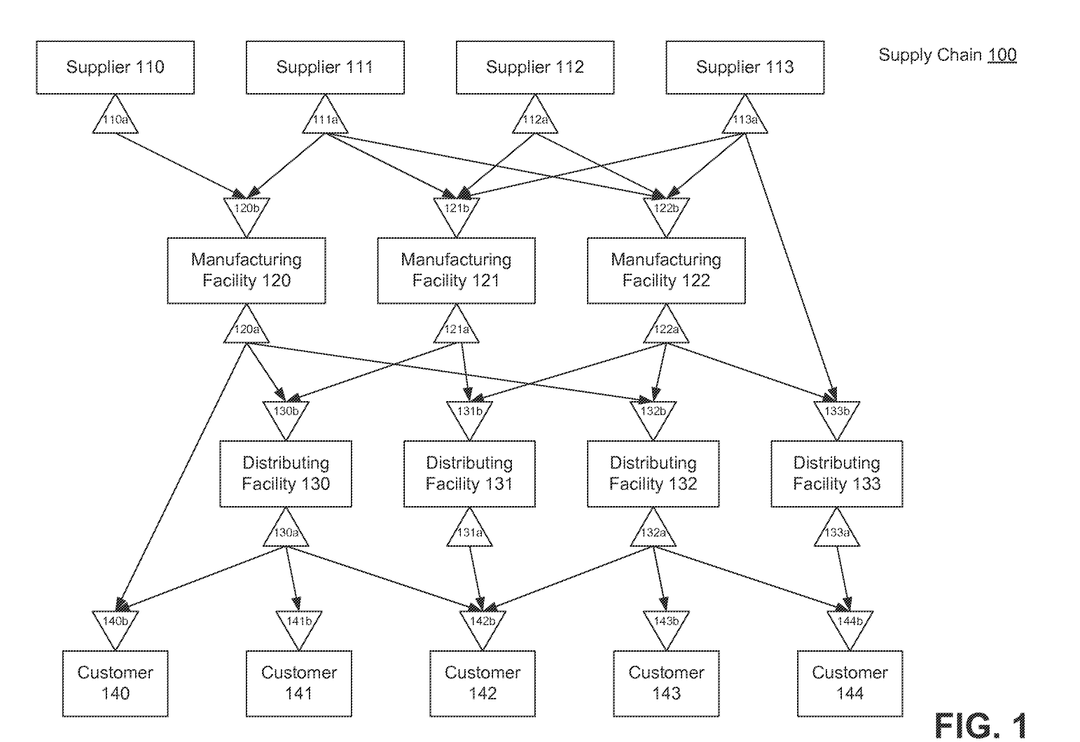

FIG. 1 illustrates an exemplary supply chain 100 in which the supply chain optimization system consistent with the disclosed embodiments may be implemented. As shown in FIG. 1, supply chain 100 may include a plurality of supply chain entities, such as suppliers 110-113, manufacturing facilities 120-122, distributing facilities 130-133, and customers 140-144.

Suppliers 110-113 may supply individual items to one or more of manufacturing facilities 120-122, one or more of distributing facilities 130-133, and one or more of customers 140-144. An item, as used herein, may represent any type of physical good that is designed, developed, manufactured, and/or delivered by supplier 110. Non-limiting examples of the items may include engines, tires, wheels, transmissions, pistons, rods, shafts, electronic controls, sensors, or any other suitable component of a product.

Manufacturing facilities 120-122 may manufacture or assemble products by using one or more individual items received from suppliers 110-113. A product, as used herein, may represent any type of finished goods that is manufactured or assembled by a manufacturing facility. The product may include one or more components, parts, or materials supplied from suppliers 110-113. Non-limiting examples of the products may include chemical products, mechanical products, pharmaceutical products, food, and fixed or mobile machines such as trucks, cranes, earth moving vehicles, mining vehicles, backhoes, material handling equipment, farming equipment, marine vessels, on-highway vehicles, or any other type of movable machine that operates in a work environment. The products manufactured by different manufacturing facilities 120-122 may be identical, or may be different from each other. Manufacturing facilities 120-122 may respectively deliver the manufactured products to one or more distributing facilities 130-133, or directly to one or more customers 140-144.

Distributing facilities 130-133 may store individual items received from one or more suppliers 110-113, and may distribute the individual items to customers 140-144 for sale as service or replacement parts for existing products. In addition, distributing facilities 130-133 may store manufactured products received from one or more manufacturing facilities 120-122, and may distribute the manufactured products to customers 140-144. In some embodiments, one of distributing facilities 130-133 may distribute the individual items or manufactured products to another one of distributing facilities 130-133, before the individual items or manufactured products are finally distributed to customers 140-144.

Although supply chain 100 shown in FIG. 1 includes four suppliers 110-113, three manufacturing facilities 120-122, four distributing facilities 130-133, and five customers 140-144, those skilled in the art will appreciate that supply chain 100 may include any number of suppliers, manufacturing facilities, distributing facilities, and dealers.

The supply chain entities in supply chain 100 may include upstream supply chain entities, such as suppliers 110-113, and downstream supply chain entities, such customers 140-144. In supply chain 100, items or products may flow in a direction from upstream supply chain entities to downstream supply chain entities. Inside each supply chain entity, at least one of a downstream inventory and an upstream inventory may be included. Downstream inventory 110a-133a may include inventories of products, parts, or subsystems that a supply chain entity may need to keep before the products, parts, or subsystems may be accepted by the supply chain entity's downstream supply chain entities. For example, manufacturing facility 120 may include a downstream inventory 120a of products before the products can be transported to and accepted by distributing facility 130.

On the other hand, upstream inventory 120b-144b may include inventories of products, parts, or subsystems that a supply chain entity receives from the supply chain entity's upstream supply chain entities and may need to keep before the products, parts, or subsystems may be used in manufacturing or other transactional processes. In the same example above, manufacturing facility 120 may also include an upstream inventory 120b of engines from supplier 110 before the work machines may be manufactured using the engines and other parts or subsystems. Further, similar to manufacturing facility 120, suppliers 110-113 may respectively include downstream inventories 110a-113a; manufacturing facilities 121 and 122 may respectively include downstream inventories 121a and 122a and upstream inventories 121b and 122b; distributing facilities 130-133 may respectively include downstream inventories 130a-133a and upstream inventories 130b-133b; and customers 140-144 may respectively include upstream inventories 140b-144b.

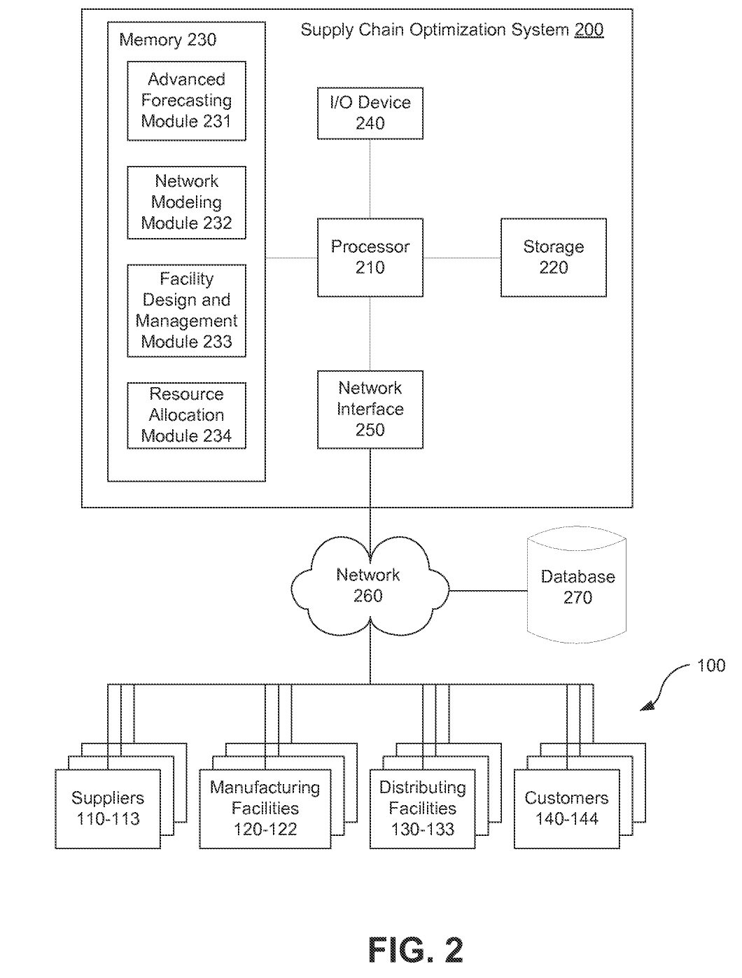

When customers 140-144 make demands to manufacturing facilities 120-122 or distributing facilities 130-133, the structure of the distribution network may be designed to fulfill the demand. The design of the distribution network may be determined according to a plurality of objectives including, for example, inventory cost, profit of the business, time taken to fulfill the demand, environmental impact, resilience of the network, total route distance, etc. The determination may be carried out according to disclosed embodiments by an exemplary system as shown in FIG. 2. The system disclosed herein may consider one or more of these objectives simultaneously in determining the structure of the distribution network. The objectives considered by the system may be competing with one another. The system may use a nonlinear programming technique to balance the competing objectives.

FIG. 2 illustrates an exemplary supply chain optimization system 200 (hereinafter referred to as “system 200”) consistent with certain disclosed embodiments. As shown in FIG. 2, system 200 may include one or more hardware and/or software components configured to display, collect, store, analyze, evaluate, distribute, report, process, record, and/or sort information related to logistics network management. System 200 may include one or more of a processor 210, a storage 220, a memory 230, an input/output (I/O) device 240, and a network interface 250. System 200 may be connected via network 260 to database 270 and supply chain 100, which may include one or more of supply chain entities, such as suppliers 110-113, manufacturing facilities 120-122, distributing facilities 130-133, and customers 140-144. That is, system 200 may be connected to computers or databases stored at one or more of the supply chain entities.

System 200 may be a server, client, mainframe, desktop, laptop, network computer, workstation, personal digital assistant (PDA), tablet PC, scanner, telephony device, pager, and the like. In one embodiment, system 200 may be a computer configured to receive and process information associated with different supply chain entities involved in supply chain 100, the information including purchasing orders, inventory data, and the like. In addition, one or more constituent components of system 200 may be co-located with any one of the supply chain entities.

Processor 210 may include one or more processing devices, such as one or more microprocessors from the Pentium™ or Xeon™ family manufactured by Intel™, the Turion™ family manufactured by AMD™, or any other type of processors. As shown in FIG. 2, processor 210 may be communicatively coupled to storage 220, memory 230, I/O device 240, and network interface 250. Processor 210 may be configured to execute computer program instructions to perform various processes and method consistent with certain disclosed embodiments. In one exemplary embodiment, computer program instructions may be loaded into memory 230 for execution by processor 210.

Storage 220 may include a volatile or non-volatile, magnetic, semiconductor, tape, optical, removable, nonremovable, or other type of storage device or computer-readable medium. Storage 220 may store programs and/or other information that may be used by system 200.

Memory 230 may include one or more storage devices configured to store information used by system 200 to perform certain functions related to the disclosed embodiments. In one embodiment, memory 230 may include one or more modules (e.g., collections of one or more programs or subprograms) loaded from storage 220 or elsewhere that perform (i.e., that when executed by processor 210, enable processor 210 to perform) various procedures, operations, or processes consistent with the disclosed embodiment. For example, memory 230 may include an advanced forecasting module 231, a network modeling module 232, a facility design and management module 233, and a resource allocation module 234.

Advanced forecasting module 231 may generate forecast information related to one or more items at any one of the supply chain entities based on historical data associated with the item. For example, advanced forecasting module 231 may forecast a future demand for an item at each one of manufacturing facilities 120-122 and distributing facilities 130-133 based on respective historical demand data for that item at manufacturing facilities 120-122 and distributing facilities 130-133. In addition, advanced forecasting module 231 may forecast the future demand for the item at suppliers 110-113 by combining the forecasted demand for the item at each one of manufacturing facilities 120-122 and distributing facilities 130-133.

Network modeling module 232 may receive the forecasted information from advanced forecasting module 231 and simulate and optimize the flow of materials (i.e., items, parts, products, etc.) between the supply chain entities and the structure of the supply chain network in order to meet certain business goals or objectives of the entire organization. The business goals or objectives may include at least one of response time, costs, profit, return on net assets, inventory turns, inventory level, service level, resilience of the supply chain network, costs, environmental impact, total route distance, etc. Network modeling module 232 may simulate the flow of materials and optimize the structure of the supply chain network based on a number of parameters, such as geographical locations of each one of the supply chain entities, the transportation methods (e.g., air, ship, truck, etc.), the capacities of the transportation links (e.g., quantity of materials that can be transported via a certain route), and the manufacturing capacities of the manufacturing facilities. Based on the simulation results and other information such as production costs, transportation costs, and regional sales price, and the like, network modeling module 232 may generate information such as gross revenue, cost of goods sold, and profit related to one or more products or parts.

Network modeling module 232 may further generate an optimized structure of the supply chain network based on the parameters and information discussed above. The optimized structure of the supply chain network may specify, for example, the links among the entities used to fill the demand for the item, the transportation methods used to transport materials and goods from one entity to another, the inventory level that should be maintained at each entity, etc.

Facility design and management module 233 may receive the forecasted information from advanced forecasting module 231 and the simulation results from network modeling module 232 and may determine the physical structure and dimension of one or more of manufacturing facilities 120-122 and distributing facilities 130-133 based on the received information. For example, facility design and management module 233 may receive forecasted information representing quantity of the incoming items to be received at manufacturing facilities 120-122 and distributing facilities 130-133. Based on this forecasted information, facility design and management module 233 may determine dimensions and locations of shelving, racks, aisles, and the like, of manufacturing facilities 120-122 and distributing facilities 130-133. Facility design and management module 233 may also determine the location of incoming items within manufacturing facilities 120-122 and distributing facilities 130-133, based on the forecasted information. Moreover, facility design and management module 233 may simulate the movement of resources (e.g., workers, machines, transportation vehicles, etc.) throughout manufacturing facilities 120-122 and distributing facilities 130-133 over time. Still further, facility design and management module 233 may modify input information in order to achieve one or more of the business goals.

Resource allocation module 234 may receive availability data representing the quantity of one or more items that are available at suppliers 110-113. When the availability data is less than the forecasted demand data of the item at suppliers 110-113, resource allocation module 234 may allocate the available items at manufacturing facilities 120-122, distributing facilities 130-133, and customers 140-144 in order to achieve one or more of the business goals associated with the entire organization.

I/O device 240 may include one or more components configured to communicate information associated with system 200. For example, I/O device 240 may include a console with an integrated keyboard and mouse to allow a user to input parameters associated with system 200 and/or data associated with supply chain 100. I/O device 240 may include one or more displays or other peripheral devices, such as, for example, printers, cameras, microphones, speaker systems, electronic tablets, bar code readers, scanners, or any other suitable type of I/O device 240.

Network interface 250 may include one or more components configured to transmit and receive data via network 260, such as, for example, one or more modulators, demodulators, multiplexers, de-multiplexers, network communication devices, wireless devices, antennas, modems, and any other type of device configured to enable data communication via any suitable communication network. Network interface 250 may also be configured to provide remote connectivity between processor 210, storage 220, memory 230, I/O device 240, and/or database 270, to collect, analyze, and distribute data or information associated with supply chain 100 and supply chain optimization.

Network 260 may be any appropriate network allowing communication between or among one or more computing systems, such as, for example, the Internet, a local area network, a wide area network, a WiFi network, a workstation peer-to-peer network, a direct link network, a wireless network, or any other suitable communication network. Connection with network 260 may be wired, wireless, or any combination thereof.

Database 270 may be one or more software and/or hardware components that store, organize, sort, filter, and/or arrange data used by system 200 and/or processor 210. Database 270 may store one or more tables, lists, or other data structures containing data associated with logistics network management. For example, database 270 may store operational data associated with each one of the supply chain entities, such as inbound and outbound orders, production schedules, production costs, and resources. The data stored in database 270 may be used by processor 210 to receive, categorize, prioritize, save, send, or otherwise manage data associated with logistics network management.

### INDUSTRIAL APPLICABILITY

The disclosed supply chain optimization system 200 may efficiently provide optimized supply chain designs for any business organization to achieve one or more desired business goals or objectives. Based on the disclosed system and methods, effects of variable input parameters may be analyzed, and the robustness, efficiency, and accuracy of the supply chain designs may be significantly improved.

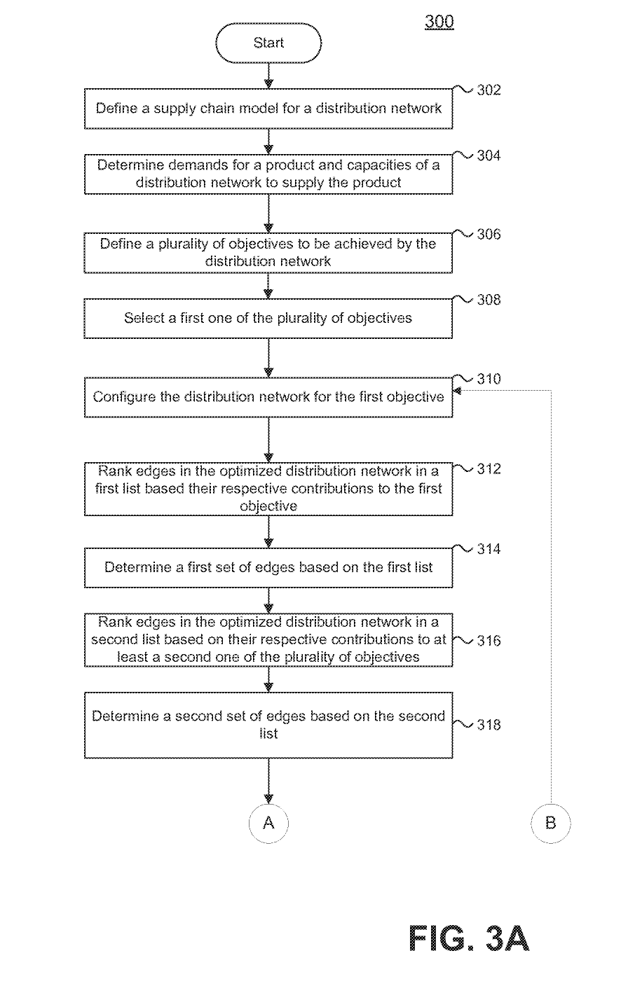

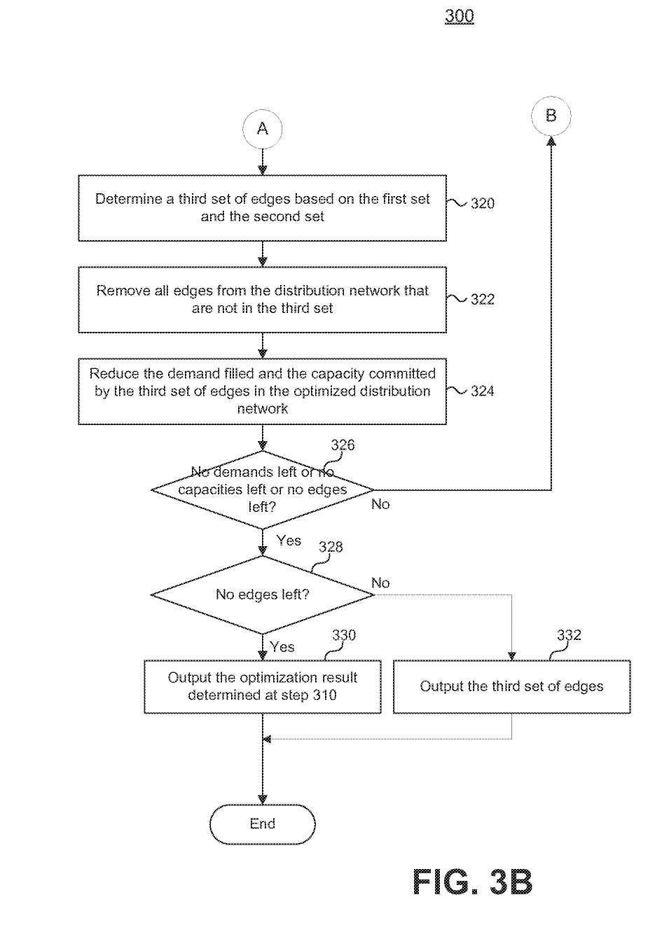

FIGS. 3A and 3B illustrate a flow chart of an exemplary process 300 for supply chain optimization by considering competing objectives, consistent with a disclosed embodiment. According to process 300, processor 210 may first generate a supply chain model for a distribution network or a supply chain, such as supply chain 100 of FIG. 1.

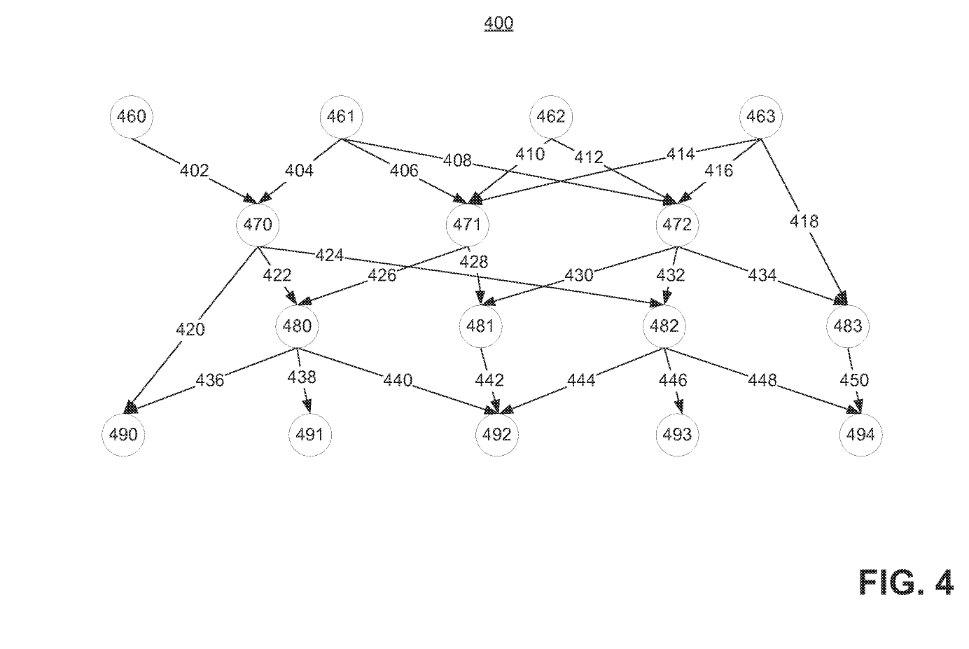

FIG. 4 depicts an exemplary supply chain model 400 that processor 210 generates for supply chain 100. Supply chain model 400 includes a plurality of nodes 460-463, 470-472, 480-483, and 490-494 representing the supply chain entities, such as suppliers 110-113, manufacturing facilities 120-122, distributing facilities 130-133, and customers 140-144. Each node may have properties attached thereto to represent, for example, inventory volume, inventory cost, manufacturing capacity, or demand of the corresponding supply chain entity.

In addition, supply chain model 400 may include a plurality of edges 402-450 represented by lines connecting the nodes. The edges may represent, for example, flow of components, materials, or parts from one supply chain entity to another. Each edge includes an arrow indicating a direction of the flow. Each customer node is connected with at least one supply node by a plurality of edges that form one or more routes. For example, customer node 490 is connected with supply node 460 by edges 402 and 420 that form a first route. Customer node 490 is also connected with supply node 460 by edges 402, 422, and 436 that form a second route.

Each edge in supply chain model 400 includes one or more properties, such as transportation volume, transportation time, transportation cost, tariff, energy price, environmental impact (e.g., carbon monoxide or other airborne emission), etc. Each property of an edge may be assigned a numerical value, which may be adjusted to optimize the supply chain model to achieve a given objective.

Referring back to FIG. 3A, at step 304, processor 210 determines the demands for a product and the capacities to supply the product. The demands and capacities may be determined based on user inputs. Alternatively, the demands and capacities may be determined by monitoring the supply chain entities of supply chain 100.

At step 306, processor 210 defines a plurality of objectives to be achieved by the supply chain. Examples of the desired business objectives may include minimizing response time, maximizing profit, maximizing return on net assets, minimizing inventory cost, maximizing inventory turns, maximizing service level, maximizing a resilience of the supply chain, and minimizing the environmental impact. The resilience of a supply chain may be defined as the percentage of a resulting business goal at risk should any one of the supply chain entities perform at less than their expected performance value or fail completely. For example, referring to FIG. 1, when all of the supply chain entities in supply chain 100 perform at their respective expected performance value, supply chain 100 may generate a profit P1. When manufacturing facility 121 fails, it is not possible to supply product to customer 142. Then, supply chain 100 may only generate a profit P2. Then, the resilience of supply chain 100 may be defined as:

Resilience=P2/P1.

As another example, the profit P of supply chain 100 may be defined as:

P=[(# of products sold)×(profit margin per product sold)]−total transportation cost of all connections in the supply chain network−total inventory cost at all locations in the supply chain network−any tariff incurred between supply chain entities.

The objectives of supply chain 100 may compete with one another. For example, when supply chain 100 achieves a maximum profit, the resilience of supply chain 100 may be significantly compromised. As a result, the operation of supply chain 100 may be easily disrupted even by a minor abnormality at only one supply chain entity. The methods and systems disclosed herein may consider these competing objectives simultaneously in optimizing supply chain 100 so as to achieve a balanced distribution network structure.

At step 308, processor 210 may select a first one of the plurality of objectives to configure supply chain 100. Processor 210 may select the first objective according to a user input. At step 310, processor 210 may configure or optimize the supply chain to achieve the selected first objective. In particular, processor 210 may determine a network structure for supply chain model 400 that when implemented in supply chain may achieve the first objective. The configuration of supply chain 100 may be achieved by various methods known in the art. For example, processor 210 may apply the methods disclosed in U.S. Provisional Application No. 61/940,946, filed Feb. 18, 2014 and U.S. Provisional Application No. 61/891,974, filed Oct. 17 2013, which are hereby incorporated by reference in their entireties.

In configuring supply chain 100, processor 210 may determine the numerical value assigned to the property of each edge in supply chain model 400 in order to achieve the first objective. For example, to achieve a minimum cost for the supply chain model, the value of the transportation cost, the value of the transportation volume, or the value of the transportation time may be adjusted by processor 210. At the same time, the values of other properties may change accordingly as the supply chain is optimized for cost. As a result, in an optimized supply chain model, the value of a relevant property of an edge may represent an optimized contribution by the edge to a given objective of the supply chain. For example, a transportation cost of edge 402 may represent an optimized contribution by edge 402 to the overall cost of supply chain model 400. Here, the optimized contribution refers to a particular value of each edge that may be implemented in the supply chain to achieve the selected objective.

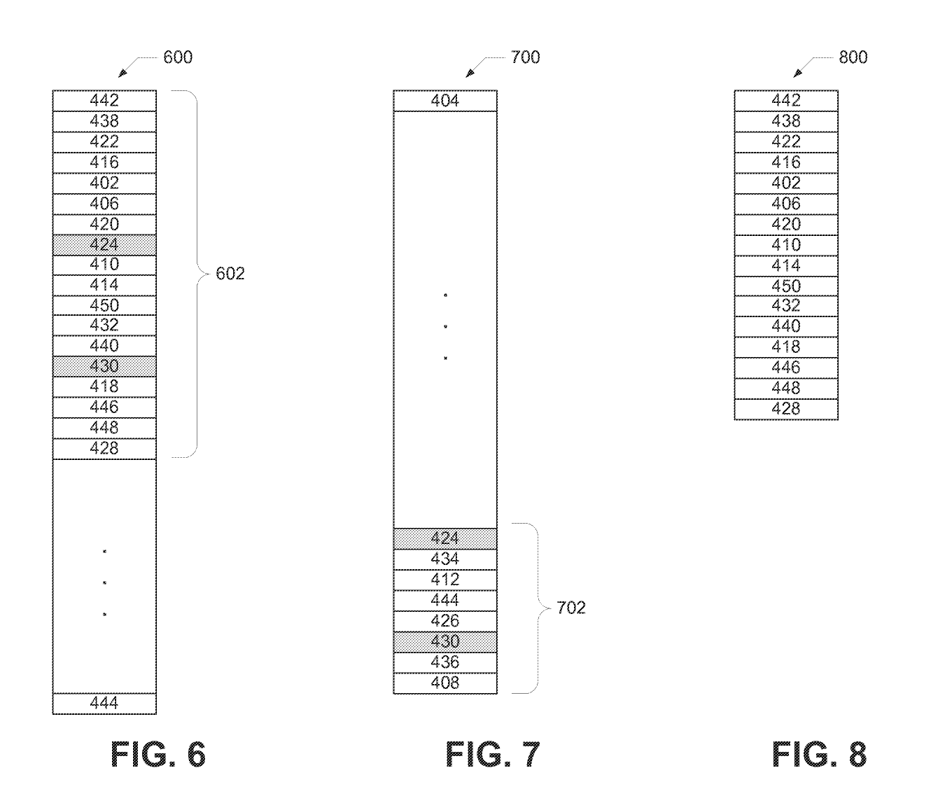

At step 312, processor 210 may rank all of the edges in supply chain model 400 according to their respective optimized contributions to the first objective. Processor 210 may analyze the numerical values determined at step 310 that represent the properties of the edges. Processor 210 may place the ranked edges in a first list. FIG. 6 illustrates an embodiment of the first list (list 600), showing a portion of the ranked edges. The ranked edges in the first list may be arranged in a descending order according to their optimized contributions to the first objective. As a result, the edge (e.g., edge 442) at the top of the first list may have the best performance with respect to the first objective, and the edge (e.g., edge 444) at the bottom of the first list may have the poorest performance with respect to the first objective.

For example, when the first objective is maximizing the resilience of supply chain 100, the edges of supply chain model 400 may be ranked in the first list (e.g., list 600) so that the most reliable edge (e.g., edge 442) is placed at the top of the first list and the most unreliable edge (e.g., edge 444) is placed at the bottom of the first list. As another example, when the first objective is minimizing the cost of supply chain 100, the edges of supply chain model 400 may be ranked in the first list so that the edge with the lowest cost is placed at the top of the first list and the edge with the greatest cost is placed at the bottom of the first list. Alternatively, the ranked edges in the first list may also be arranged in an ascending order, which one of ordinary skill in the art will readily appreciate in view of this disclosure.

At step 314, processor 210 may identify or determine a first set of edges based on the first list. As shown in FIG. 6, the first set of edges (e.g., set 602) may include a predetermined number of edges that contribute the most to or have the best performance with respect to the first objective. For example, when the edges in the first list are ranked in the descending order as discussed above, processor 210 may select the top 10% of the edges from the first list as the first set of edges. Alternatively, the processor 210 may select, for example, the top 300 edges from the first list (e.g., list 600) as the first set of edges (e.g., set 602). One of ordinary skill in the art will recognize that the first set of edges may be identified from the bottom of the first list if the edges are ranked in the ascending order in the first list.

At step 316, processor 210 may determine the respective contributions by the edges to a second objective that is different from the first objective. This determination is based on the supply chain model obtained in step 310, which is configured for the first objective. Since the supply chain model in step 310 is configured or optimized for the first objective, the contributions by the edges to the second objective are not necessarily optimized. In other words, the value assigned to each edge in the supply chain model that is configured for the first objective is not necessarily designed to achieve the second objective. Accordingly, the contributions of the edges in the supply chain model are not optimized for the second objective.

Based on the unoptimized contributions by the edges to the second objective, processor 210 rank the edges in a second list. FIG. 7 illustrates an embodiment of the second list (list 700), showing a portion of the ranked edges. The ranked edges in the second list (e.g., list 700) may be arranged in a descending order according to their unoptimized contributions to the second objective. As a result, the edge (e.g., 404) with the best unoptimized performance with respect to the second objective is placed at the top of the second list, and the edge (e.g., 408) with the poorest unoptimized performance with respect to the second objective is placed at the bottom of the second list.

For example, when the second objective is maximizing the resilience of supply chain 100, the edges may be ranked in the second list (e.g., list 700) so that the most reliable edge (although unoptimized) is placed at the top of the second list and the most unreliable edge is placed at the bottom of the second list. As another example, when the second objective is minimizing the cost, the edges may be ranked in the second list so that the edge with the lowest cost is placed at the top of the second list and the edge with the greatest cost is placed at the bottom of the second list. Alternatively, the ranked edges in the second list may also be arranged in an ascending order, which one of ordinary skill in the art will readily appreciate in view of this disclosure.

At step 318, processor 210 may identify or determine a second set of edges based on the second list obtained at step 316. As shown in FIG. 7, the second set of edges (e.g., set 702) may include a predetermined number of edges that contribute the least to or have the poorest performance with respect to the second objective. For example, when the edges in the second list (e.g., list 700) are ranked in the descending order as discussed above, processor 210 may select the bottom 5% of the edges from the second list as the second set of edges. Alternatively, processor 210 may select the bottom 100 edges from the second list as the second set of edges. One of ordinary skill in the art will recognize that the second set of edges may be identified from the top of the second list if the edges are ranked in the ascending order in the second list.

At step 320, processor 210 may determine or identify a third set of edges based on the first set and the second set of edges. In particular, processor 210 may identify the edges that are in the first set but not in the second and form the third set of edges accordingly. FIG. 8 illustrates an embodiment of the third set of edges. The third set of edges 800 is identified based on first set 602 from first list 600 and second set 702 from second list 700. For example, although edges 424 and 430 are in first set 602 that have relatively good performance for the first objective, they are also second set 702 that have relatively poor performance for the second objective. As a result, processor 210 does not include edges 424 and 430 in generating third set 800. As a result, third set 800 includes all edges in first set 602 except edges 424 and 430 that are also in second set 702.

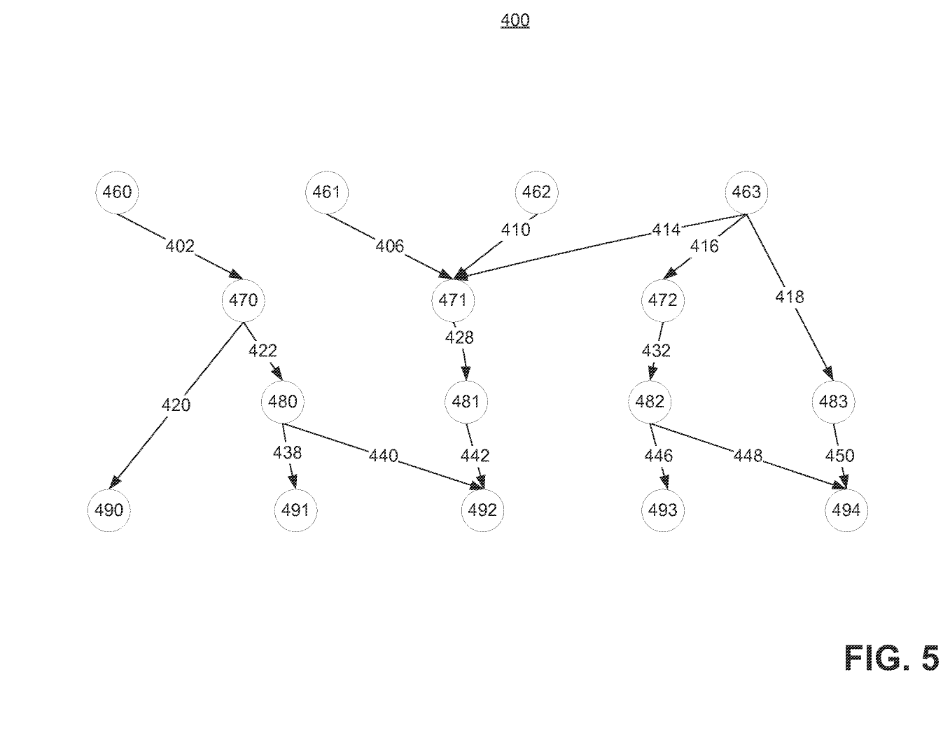

At step 322, processor 210 may retain the third set of edges (e.g., set 800) and remove all other edges from supply chain model 400. FIG. 5 illustrates an embodiment of supply chain model 400 with only the third set of edges remaining in the model.

At step 324, processor 210 may then remove the demands for the product that will be fulfilled by the third set of edges and the supplies of the product that will be committed by the third set of edges. More particularly, processor 210 may analyze the third set of edges to determine the demands filled by the third set of edges and the supplies committed by the third set of edges. Processor 210 may then remove those demands and supplies from supply chain model 400.

At step 326, processor 210 may determine if there are any remaining demands or any remaining capacities or any remaining edges. If the demands have not been completely fulfilled, the capacities have not been completely committed, and the edges have not been completely removed (“No” at step 326), processor 210 may proceed back to step 310 to start the next iteration based on supply chain model 400 with the remaining third set of edges.

According to a further embodiment, processor 210 may set a minimum demand value, a minimum supply value, and a minimum edge value. At step 326, processor 210 may compare the remaining demands in supply chain model 400 with the minimum demand value. If the remaining demands are less than the minimum demand value, processor 210 may treat that all demands have been fulfilled. Similarly, processor 210 may compare the remaining supplies in supply chain model 400 with the minimum supply value. If the remaining supplies are less than the minimum supply value, processor 210 may treat that all supplies have been committed. Still similarly, processor 210 may compare the number of remaining edges in the supply chain model 400 with the minimum edge value. If the number of remaining edges is less than the minimum edge value, processor 210 may treat that all edges have been removed.

If there are no remaining demands or no remaining capacities or no remaining edges within supply chain 100 (“Yes” at step 326), processor 210 may then proceed to step 328. At step 328, processor 210 may determine whether the iteration is terminated because there are no remaining edges. If the number of edges left in supply chain model 400 is less than the minimum edge value, processor 210 determines that there are demands that cannot be satisfied (“Yes” at step 328). Accordingly, processor 210 may output the optimization result at step 310, which provides an optimized network structure with respect to the first objective.

If the number of edges in supply chain model 400 is greater than the minimum edge value, processor 210 may determine that all demands will be satisfied (“No” at step 338). Accordingly, processor 210 may output an optimization result, which provides an optimized network structure with only the third set of edges.

According to an embodiment, processor 210 may determine the minimum demand value, the minimum supply value, and the minimum edge value based on user input. The user input may specify the values in an absolute number or a percentage number. For example, the minimum demand value may be set to 10 products or 1% of the initial demands.

According to another embodiment, if there are more demands than supplies, there are remaining demands that cannot be fulfilled when all supplies are committed. In this case, processor 210 may consider relationships between the supply nodes and customer nodes so as to give higher priorities to the customer nodes who have established relationships with the supply nodes. As a result, the demands of the established customer nodes may be fulfilled before other customer nodes.

One of ordinary skill in the art will appreciate that processor 210 may consider more than two competing objectives during the optimization of supply chain 100 according to process 300. For example, at step 316, in addition to a second objective, processor 210 may also consider a third objective. Processor 210 may determine unoptimized contributions by the edges to the third objective and rank the edges of supply chain model 400 in a third list. Processor 210 may rank the edges according to their unoptimized contributions to the third objective. At step 318, processor 210 may then identified from the third list a predetermined number of edges that have the poorest performance with respect to the third objective. Processor 210 may then include these additional edges in the second set of edges. In other words, the second set of edges may include a predetermined number of edges that have the poorest performance with respect to the second objective and a predetermined number of edges that have the poorest performance with respect to the third objective. At step 320, processor 210 may then determine the third set of edges based on the first set of edges and the second set of edges as described above.

The distribution network developed using the methods disclosed here may have distinct advantages over prior art. First, the performance of the distribution network with respect to all objectives is higher than what can be achieved by conventional methods. Second, over a wider range of problem types, such as different number of demands and supplies, different costs and times between supplies and demands, different tariff effects, etc., the performance of the distribution network obtained by the methods disclosed here is more consistent than the conventional methods. In particular, by selecting edges that have the best performance with respect to one objective, but not the poorest performance with respect to other competing objectives, system 200 considers and balances multiple competing objectives during the optimization of supply chain 100. As a result, the disclosed system and method ensure that the resulting distribution network structure has optimal performance with respect to the first objective, while maintaining satisfactory performance with respect to other objectives (e.g., the second objective, the third objective, etc.).

It will be apparent to those skilled in the art that various modifications and variations can be made to the disclosed supply chain optimization system. Other embodiments will be apparent to those skilled in the art from consideration of the specification and practice of the disclosed supply chain optimization system. It is intended that the specification and examples be considered as exemplary only, with a true scope being indicated by the following claims and their equivalents.

What is claimed is:

1. A computer-implemented method for designing a supply chain for multiple objectives based on a supply chain model, comprising:
defining a plurality of objectives for the supply chain model, the supply chain model including a plurality of edges connecting one or more demands with one or more supplies;
selecting a first one of the plurality of objectives and at least a second one of the plurality of objectives;
configuring, using a controller, the supply chain model for the first objective;
identifying, using the controller, a subset of the plurality of edges based on the supply chain model configured for the first objective and relationships between the plurality of edges and the at least second objective; and
presenting to a user a design of the supply chain according to the supply chain model having the identified subset of the plurality of edges.

2. The method of claim 1, further comprising:
operating the supply chain according to the identified subset of the plurality of edges.

3. The method of claim 1, wherein the identifying the subset of the plurality of edges further comprising:
(a) identifying a first set of edges within the supply chain model configured for the first objective according to the contributions by the plurality of edges to the first objective;
(b) determining contributions by the plurality of edges to the second objective in the supply chain model configured for the first objective;
(c) identifying a second set of edges within the supply chain model configured for the first objective according to the contributions by the plurality of edges to the second objective;
(d) identifying a third set of edges that are in the first set but not in the second set; and
(e) deleting the edges in the supply chain model other than the third set of edges;

4. The method of claim 3, further comprising:
(f) removing the demands filled by the third set of edges and the supplies committed by the third set of edges.

5. The method of claim 4, further comprising performing steps (a)-(f) iteratively.

6. The method of claim 3, further comprising:
ranking the plurality of edges in a first list according to the contributions by the edges to the first objective; and
identifying the first set of edges from the first list.

7. The method of claim 6, wherein the plurality of edges are ranked in the first list in a descending order according to the contributions by the edges to the first objective and the first set of edges are selected from the top of the first list.

8. The method of claim 6, further comprising:
ranking the edges in a second list according to the contributions by the edges to the second objective; and
identifying the second set of edges from the second list.

9. The method of claim 8, wherein the edges are ranked in the second list in a descending order according to the contributions by the edges to the second objective and the second set of edges are selected from the bottom of the second list.

10. The method of claim 5, further comprising:
determining at least one of the following is true:
(g) the number of edges remaining in the supply chain model is below a minimum edge threshold;
(h) the number of demands remaining is below a minimum demand threshold; or
(i) the number of supply remaining is below a minimum supply threshold; and
terminating the iteration.

11. The method of claim 9, wherein if (g) or (h) is true, the method further comprises outputting the third set of edges as the subset of edges.

12. The method of claim 9, wherein if (i) is true, the method further comprises outputting the edges determined in step (a) as the subset of edges.

13. A computer-implemented method for operating a supply chain, comprising:
(a) defining a supply chain model for the supply chain, the supply chain model including a plurality of edges connecting a plurality of demands with a plurality of supplies;
(b) defining a first objective and a second objective for the supply chain model;
(c) configuring, by a processor, the supply chain model for the first objective, the configured supply chain model indicating contributions by the plurality of edges to the first objective;
(d) determining, by the processor, contributions by the plurality of edges to the second objective based on the supply chain model configured for the first objective;
(e) identifying a subset of edges based on the contributions by the plurality of edges to the first objective and the contributions by the plurality of edges to the second objective; and
(f) presenting to a user a design of the supply chain according to the supply chain model having the identified subset of the plurality of edges.

14. The method of claim 13, further comprising:
operating the supply chain according to the identified subset of edges.

15. The method of claim 13, wherein the step (e) further comprises:
identifying a first set of edges within the supply chain model configured for the first objective according to the contributions by the plurality of edges to the first objective;
identifying a second set of edges within the supply chain model configured for the first objective according to the contributions by the plurality of edges to the second objective;
identifying a third set of edges based on the first set of edges and the second set of edges; and
deleting the edges from the supply chain model other than the third set of edges.

16. The method of claim 15, wherein the third set of edges includes the edges in the first set but not the second set.

17. The method of claim 15, further comprising:
ranking the plurality of edges in a first list according to the contributions by the plurality of edges to the first objective;
selecting the first set of edges from the first list according to the ranks of the plurality of edges in the first list;
ranking the plurality of edges in a second list according to the contributions by the plurality of edges to the second objective; and
selecting the second set of edges from the second list according to the ranks of the plurality of edges in the second list.

18. The method of claim 13, further comprising performing the steps (c)-(e) iteratively.

19. A computer-implemented method for operating a supply chain, comprising:
defining a supply chain model for the supply chain, the supply chain model including a plurality of edges connecting a plurality of demands with a plurality of supplies;
defining a first objective and a second objective for the supply chain model;
iteratively removing a portion of the plurality of edges from the supply chain model based on first contributions by the plurality of edges to the first objective and second contributions by the plurality of edges to the second objective; and
operating the supply chain according to remaining edges in the supply chain model.

20. The model of claim 19, wherein the iterative removal of the portion of the edges includes performing the follow steps iteratively:
configuring the supply chain model for the first objective, the configured supply chain model indicating the first contributions by the plurality of edges to the first objective;
determining the second contributions by the plurality of edges to the second objective.
identifying a first set of edges based on the first contributions by the plurality of edges to the first objective;
identifying a second set of edges based on the second contributions by the plurality of edges to the second objective;
identifying a third set of edges based on the first set of edges and the second set of edges;
deleting the edges from the supply chain model other than the third set of edges; and
removing the demands filled by the remaining edges and the supplied committed by the remaining edges.
